(19) United States
(12) Patent Application Publication
(10) Pub. No.: US 2010/0200809 A1
(43) Pub. Date: Aug. 12, 2010

(54) METHOD OF ENRICHING A GASEOUS EFFLUENT WITH ACID GAS

(76) Inventors: Anne Sinquin, Bezons (FR); David Pasquier, Suresnes (FR); Raphaël Huyghe, Saint Andéol le Château (FR); Pierre-Antoine Bouillon, Lyon (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/594,627

(22) PCT Filed: Apr. 3, 2008
(86) PCT No.: PCT/FR2008/000457

§ 371 Date: Apr. 16, 2010

(30) Foreign Application Priority Data
Apr. 5, 2007 (FR) 0702495

(51) Int. Cl. C09K 3/00

(52) U.S. Cl. 252/372

(57) ABSTRACT

The present invention relates to a method of enriching a gaseous effluent with acid compounds, comprising the following stages:
feeding into a contactor R1 a feed gas and a mixture of at least two liquid phases non-miscible with one another, including an aqueous phase, the feed gas containing at least acid compounds,
establishing in said contactor predetermined pressure and temperature conditions for the formation of hydrates consisting of water and of acid compounds,
carrying the hydrates dispersed in the phase non-miscible in the aqueous phase by pumping P1 to a hydrate dissociation drum R2,
establishing in the drum the hydrate dissociation conditions,
discharging the gas resulting from the dissociation enriched in acid compounds in relation to the feed gas.

### FIELD OF THE INVENTION

The present invention relates to the field of separation of acid compounds such as the hydrogen sulfide (H₂S) or the carbon dioxide (CO₂) contained in a gas stream, for example natural gas hydrocarbon, fumes or other industrial effluents. The present invention aims to use the formation of gas hydrates in order to remove the largest possible amount of acid compounds from the gas stream so as to enrich in acid compounds another gaseous effluent while making it possible to increase the delivery pressure.

### BACKGROUND OF THE INVENTION

A known gas deacidizing method comprises a stage of extraction of the acid compounds contained in the gas to be treated by contacting this gas with the regenerated solvent in an absorber operating at the pressure of the gas to be treated, followed by a stage of thermal regeneration of the solvent generally operating at a pressure slightly higher than the atmospheric pressure. This thermal regeneration is generally carried out in a column equipped with a bottom reboiler and a top condenser allowing to cool the acid compounds released through regeneration and to recycle the condensates to the top of the regenerator as reflux.

In the prior method, regeneration of the absorbent solution laden with acid compounds is costly as regards energy consumption, which is a major drawback. Furthermore, the acid gas delivered by the regeneration is delivered at the low regeneration pressure, generally between 1 and 5 bar abs. In case of injection of these acid gases into a reservoir, a highly energy-costly compression is then required.

Document U.S. Pat. No. 7,128,777 describes a method of separation by hydrate formation of the acid gases contained in a gas stream. This patent uses water both as component of the hydrates and as transportation medium for carrying the hydrate phase to a separator, then to compressors. The dual function of water as component and as transportation medium is likely to limit the conversion of water to hydrate and to generate the formation of hydrate blocks that may clog pipes.

The present invention aims to use a non-water-miscible phase as the water dispersion and hydrate phase transportation medium, allowing both to prevent clogging risks during transportation of the hydrate slurry, to improve transfer of the acid gas to an aqueous phase and to increase the conversion ratio of the water to hydrates. This slurry is obtained using one or more amphiphilic additives possibly having the property of lowering the hydrate formation temperature and/or of modifying the formation and agglomeration mechanisms.

### SUMMARY OF THE INVENTION

The present invention thus relates to a method of enriching a gaseous effluent with acid compounds, comprising the following stages:
feeding into a contactor a feed gas and a mixture of at least two liquid phases non-miscible with one another, including an aqueous phase, the feed gas containing at least acid compounds,
establishing in said contactor predetermined pressure and temperature conditions for the formation of hydrates consisting of water and of said acid compounds,
carrying said hydrates dispersed in the phase non-miscible in the aqueous phase by pumping to a hydrate dissociation drum,
establishing in said drum the hydrate dissociation conditions,
discharging the gas resulting from the dissociation, said gas being enriched in acid compounds in relation to the feed gas.

The hydrate dispersion pressure can be increased by a factor ranging between 2 and 200 times the feed gas pressure.

At least one non-ionic, anionic, cationic or zwitterionic amphiphilic compound having at least the hydrate anti-agglomeration property can be added to said mixture.

The amphiphilic compound can comprise a hydrophilic part and a part having a high affinity with the phase non-miscible with the aqueous phase.

### BRIEF DESCRIPTION OF THE FIGURES

Other features and advantages of the invention will be clear from reading the description hereafter, given by way of non limitative example, with reference to the accompanying figures wherein:

FIG. 1 diagrammatically shows the method according to the invention,

FIG. 2 shows the testing device.

### DETAILED DESCRIPTION

The present invention notably has the following advantages:
high energy gain in relation to a conventional method,
the high-pressure delivery of acid compounds allows to do without a subsequent highly energy-costly compression in case of reinjection of the acid effluent,
increase in the conversion ratio of water to hydrate,
improved transportability of the hydrate phase,
moderate regeneration thermal levels.

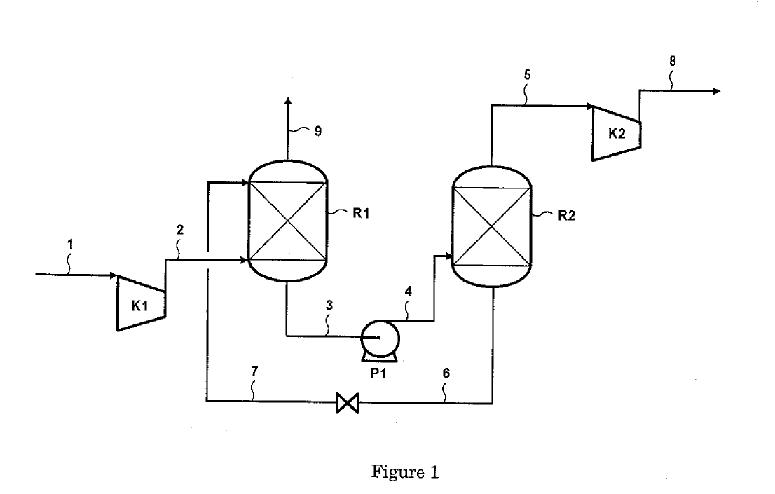

The method of enriching a gaseous effluent with acid gas using the gas hydrates as the enrichment agent comprises three main stages illustrated by FIG. 1:
(1) a first treating stage for contacting the feed gas containing acid compounds with a mixture of at least two liquid phases non-miscible with one another, at least one of which consists of water, and preferably amphiphilic molecules. The gas and the liquid phases are contacted under pressure and temperature conditions compatible with the formation of a hydrate phase made up of acid compounds and water. This formation can be assisted by adding one or more suitable additives. This first stage allows sequestration of a high proportion of acid gas in the hydrate phase. The gas hydrate particles thus enriched in acid compounds are dispersed in the non-water-miscible liquid and transported in form of a suspension of solids. The gas that is not converted to hydrate is thus depleted in acid compounds. Hit does still not correspond to the required specifications, it can be subjected to a second stage of depletion by the hydrates, or it can possibly be treated by means of another gas deacidizing method. In FIG. 1, hydrate formation occurs in contactor R1 into which the feed gas flows through line 2, after compression of the incoming gas through line 1 by means of compressor K1. Line 7 supplies the contactor with a fluid consisting of the mixture of two liquid phases non-miscible with one another, one being water, to which at least one amphiphilic compound has preferably been added. The depleted gas is discharged through line 9 whereas the hydrate slurry leaves the bottom of the contactor through line 3,
(2) a second treating stage intended to increase the acid gas partial pressure of the effluent from the previous stage. It consists in pumping (P1) the suspension of solids comprising notably the hydrate phase at a pressure 2 to 100 times higher than the pressure of the feed gas, then in heating this suspension so as to dissociate the hydrate particles enriched in acid gas into a mixture of two initial non-miscible liquids, and possibly an amphiphilic compound, and into a gas phase enriched in acid compounds at high pressure. The gaseous stream thus obtained has an acid gas content and partial pressure that is two to a hundred times higher than that of the feed gas. In FIG. 1, pump P1 delivers under pressure the slurry through line 4 into dissociation drum R2. The gas enriched in acid compounds is discharged through line 5 and possibly compressed by compressor K2 so as to be injected for example into an underground reservoir through line 8,
(3) the mixture of liquids from stage (2), predominantly comprising the two non-miscible liquids, the amphiphilic compound(s) and/or possibly other additives that can help towards formation of a hydrate suspension in form of dispersed particles, is expanded/cooled so as to be sent back through lines 6 and 7 to contactor R1 of stage 1.

### Hydrate Formation Conditions

The hydrate formation/dissociation process intended to deplete a feed gas for example in CO₂, then to enrich in CO₂ an effluent from the process is carried out in a medium comprising water—hydrates component—and a non-water-miscible solvent. At least one amphiphilic compound having the property of lowering the hydrate formation temperature and/or of modifying the formation and agglomeration mechanisms is preferably added to this mixture. These changes can be particularly turned to account for transportation of the hydrate dispersion.

The proportions of the water/solvent mixture can respectively range between 0.5/99.5 and 60/40% by volume, preferably between 10/90 and 50/50% by volume, and more precisely between 20/80 and 40/60% by volume.

The amphiphilic compounds are chemical compounds (monomer or polymer) having at least one hydrophilic or polar chemical group, with a high affinity with the aqueous phase and at least one chemical group having a high affinity with the solvent (commonly referred to as hydrophobic).

Upon contact of a water phase with a gas that can form hydrates, one observes on the one hand a low conversion ratio of water to hydrate, essentially due to the low solubility of the gas in water, and on the other hand, upon formation of these hydrates, a strong agglomeration of the particles leading to the formation of solid blocks, plugs or deposits that make the system non pumpable.

With water/solventlamphiphilic compound systems, it can be observed that, when contacting the feed gas to be treated with such mixtures, one obtains:
with judicious solvent selection, possible preferential solubilization of the acid compound(s) of the gas to be treated in the solvent,
under suitable pressure and temperature conditions, formation of hydrates enriched in acid compounds under favourable thermodynamic conditions and with a high conversion ratio of water to hydrate,
with suitable amphiphilic compounds, we obtain hydrate particles that are not aggregated in the solvent. The formation of hydrate blocks is thus avoided and the hydrate particles dispersion remains pumpable,
the use of a non-water-miscible solvent possibly allows to limit the residual water content of the enriched acid compounds released upon dissociation of the hydrates.

These advantageous properties are obtained within a very wide temperature and pressure range.

The amphiphilic compound can be added to said mixture in a proportion ranging between 0.1 and 10% by weight, preferably between 0.1 and 5% by weight, in relation to the phase non-miscible in the aqueous phase, i.e. the solvent.

The solvent used for the method can be selected from among several families: hydrocarbon-containing solvents, silicone type solvents, halogenated or perhalogenated solvents.

In the case of hydrocarbon-containing solvents, the solvent can be selected from among:
aliphatic cuts, for example isoparaffinic cuts having a sufficiently high flash point to be compatible with the method according to the invention,
organic solvents of aromatic cut or naphthenic cut type can also be used with the same flash point conditions,
pure products or mixtures selected from among the branched alkanes, cycloalkanes and alkylcycloalkanes, aromatic compounds, alkylaromatics.

The hydrocarbon-containing solvent for the method is characterized in that its flash point is above 40° C., preferably above 75° C. and more precisely above 100° C. Its crystallization point is below −5° C.

The solvents of silicone type, alone or in admixture, are for example selected from among:
linear polydimethylsiloxanes (PDMS) of (CH₃)₃-SiO-[(CH₃)₂-SiO]ₙ-Si(CH₃)₃ type with n ranging between 1 and 900, corresponding to viscosities at ambient temperature ranging between 0.1 and 10,000 mPa.s,
polydiethylsiloxanes in the same viscosity range,
cyclic polydimethylsiloxanes D₄ to D₁₀, preferably D₅ to D₈. Unit D represents the monomer unit dimethylsiloxane,
poly(trifluoropropyl methyl siloxanes).

The halogenated or perhalogenated solvents used in the method are selected from among perfluorocarbides (PFC), hydrofluoroethers (HFE), perfluoropolyethers (PFPE).

The halogenated or perhalogenated solvent used in the method is characterized in that its boiling point is greater than or equal to 70° C. at atmospheric pressure and its viscosity is below 1 Pa.s at ambient temperature and atmospheric pressure.

The amphiphilic compounds comprise a hydrophilic part that can be either neutral or anionic, or cationic, or zwitterionic. The part having a high affinity with the solvent (referred to as hydrophobic) can be hydrocarbon-containing, silicone-containing or fluoro-silicone-containing, or halogenated or perhalogenated.

The hydrocarbon-containing amphiphilic compounds used alone or in admixture to facilitate formation and/or transportation of the hydrates according to the present invention are selected from among the non-ionic, anionic, cationic or zwitterionic amphiphilic compounds.

The non-ionic compounds are characterized in that they contain:
a hydrophilic part comprising either alkylene oxide groups, hydroxy or amino alkylene groups,
a hydrophobic part comprising a hydrocarbon chain derived from an alcohol, a fatty acid, an alkylated derivative of a phenol or a polyolefin, for example derived from isobutene or butene.

The bond between the hydrophilic part and the hydrophobic part can be, for example, an ether, ester or amide function. This bond can also be obtained by a nitrogen or sulfur atom.

Examples of non-ionic amphiphilic hydrocarbon-containing compounds are oxyethylated fatty alcohols, alkoxylated alkylphenols, oxyethylated and/or oxypropylated derivatives, sugar ethers, polyol esters, such as glycerol, polyethylene glycol, sorbitol and sorbitan, mono and diethanol amides, carboxylic acid amides; sulfonic acids or amino acids.

Anionic amphiphilic hydrocarbon-containing compounds are characterized in that they contain one or more functional groups ionizable in the aqueous phase so as to form negatively charged ions. These anionic groups provide the surface activity of the molecule. Such a functional group is an acid group ionized by a metal or an amine. The acid can be, for example, carboxylic, sulfonic, sulfuric or phosphoric acid.

The following anionic amphiphilic hydrocarbon-containing compounds can be mentioned:
carboxylates such as metallic soaps, alkaline soaps or organic soaps (such as N-acyl amino acids, N-acyl sarcosinates, N-acyl glutamates and N-acyl polypeptides),
sulfonates such as alkylbenzenesulfonates (i.e. alkoxylated alkylbenzenesulfonates), paraffin and olefin sulfonates, ligosulfonates or sulfonsuccinic derivatives (such as sulfosuccinates, hemisulfosuccinates, dialkylsulfosuccinates, for example sodium dioctyl-sulfo succinate),
sulfates such as alkylsulfates, alkylethersulfates and phosphates.

Cationic amphiphilic hydrocarbon-containing compounds are characterized in that they contain one or more functional groups ionizable in the aqueous phase so as to form positively charged ions. These cationic groups provide the surface activity of the molecule.

Examples of cationic hydrocarbon-containing compounds are:
alkylamine salts such as:
   alkylamine ethers,
   quaternary ammonium salts such as alkyl trimethyl ammonium derivatives or tetra-alkylammonium derivatives or alkyl dimethyl benzyl ammonium derivatives,
   alkoxylated alkyl amine derivatives,
sulfonium or phosphonium derivatives, for example tetra-alkyl phosphonium derivatives,
heterocyclic derivatives such as the pyridinium, imidazolium, quinolinium, piperidinium or morpholinium derivatives.

Zwitterionic hydrocarbon-containing compounds are characterized in that they have at least two ionizable groups, such that at least one is positively charged and at least one is negatively charged. The groups are selected from among the anionic and cationic groups described above, such as for example betaines, alkyl amido betaine derivatives, sulfobetaines, phosphobetaines or carboxybetaines.

The amphiphilic compounds comprising a neutral, anionic, cationic or zwitterionic hydrophilic part can also have a silicone or fluoro-silicone hydrophobic part (defined as having a high affinity with the non-water-miscible solvent). These silicone, oligomers or polymers, amphiphilic compounds can also be used for water/organic solvent mixtures, water/halogenated or perhalogenated solvent mixtures or water/silicone solvent mixtures.

The neutral silicone amphiphilic compounds can be oligomers or copolymers of PDMS type wherein the methyl groups are partly replaced by alkylene polyoxide groups (of ethylene polyoxide or propylene polyoxide type or an ethylene polyoxide and propylene polymer blend) or pyrrolidone groups such as PDMS/hydroxy-alkylene oxypropyl-methyl siloxane derivatives or alkyl methyl siloxane/hydroxy-alkylene oxypropyl-methyl siloxane derivatives.

These copolyols obtained by hydrosilylation reaction have reactive terminal hydroxyl groups. They can therefore be used to obtain ester groups, for example by reaction of a fatty acid, or alkanolamide groups, or glycoside groups.

Silicone polymers comprising alkyl side groups (hydrophobic) directly linked to the silicon atom can also be modified by reaction with fluoro alcohol type molecules (hydrophilic) so as to form amphiphilic compounds.

The surfactant properties are adjusted with the hydrophilic group/hydrophobic group ratio.

PDMS copolymers can also be made amphiphilic by anionic groups such as phosphate, carboxylate, sulfate or sulfosuccinate groups. These polymers are generally obtained by reaction of acids on the terminal hydroxide functions of polysiloxane alkylene polyoxide side chains.

PDMS copolymers can also be made amphiphilic by cationic groups such as quaternary ammonium groups, quatemized alkylamido amine groups, quaternized alkyl alkoxy amine groups or a quaternized imidazoline amine. It is possible to use, for example, the PDMS/benzyl trimethyl ammonium methylsiloxane chloride copolymer or the halogen N-alkyl-N,N dimethyl-(3-siloxanylpropyl)ammonium derivatives.

PDMS copolymers can also be made amphiphilic by betaine type groups such as a carboxybetaine, an alkylamido betaine, a phosphobetaine or a sulfobetaine. In this case, the copolymers comprise a hydrophobic siloxane chain and, for example, a hydrophilic organobetaine part of general formula:

(Me₃SiO)(SiMe₂O)ₐ(SiMeRO)SiMe₃

with R=(CH²)₃⁺NMe₂(CH₂)_{b}COO⁻; a=0,10; b=1,2

The amphiphilic compounds comprising a neutral, anionic, cationic or zwitterionic hydrophilic part can also have a halogenated or perhalogenated hydrophobic part (defined as having a high affinity with the non-water-miscible solvent). These halogenated amphiphilic compounds, oligomers or polymers, can also be used for water/organic solvent or water/halogenated or perhalogenated solvent or water/silicone solvent mixtures.

The halogenated amphiphilic compounds such as, for example, fluorine compounds can be ionic or non-ionic. The following can be mentioned in particular:
non-ionic amphiphilic halogenated or perhalogenated compounds such as the compounds of general formula Rf(CH₂)(OC₂H₄)ₙOH, wherein Rf is a partly hydrogenated perfluorocarbon or fluorocarbon chain, wherein n is an integer at least equal to 1, the fluorine non-ionic surfactant agents of polyoxyethylene-fluoroalkylether type,
the ionizable amphiphilic compounds for forming anionic compounds, such as perfluorocarboxylic acids and their salts, or perfluorosulfonic acids and their salts, perfluorophosphate compounds, mono and dicarboxylic acids derived from perfluoro polyethers and their salts, mono and disulfonic acids derived from perfluoro polyethers and their salts, perfluoro polyether phosphate amphiphilic compounds and perfluoro polyether diphosphate amphiphilic compounds,
perfluorinated cationic or anionic amphiphilic halogenated compounds or those derived from perfluoro polyethers having 1, 2 or 3 hydrophobic side chains, ethoxylated fluoroalcohols, fluorinated sulfonamides or fluorinated carboxamides.

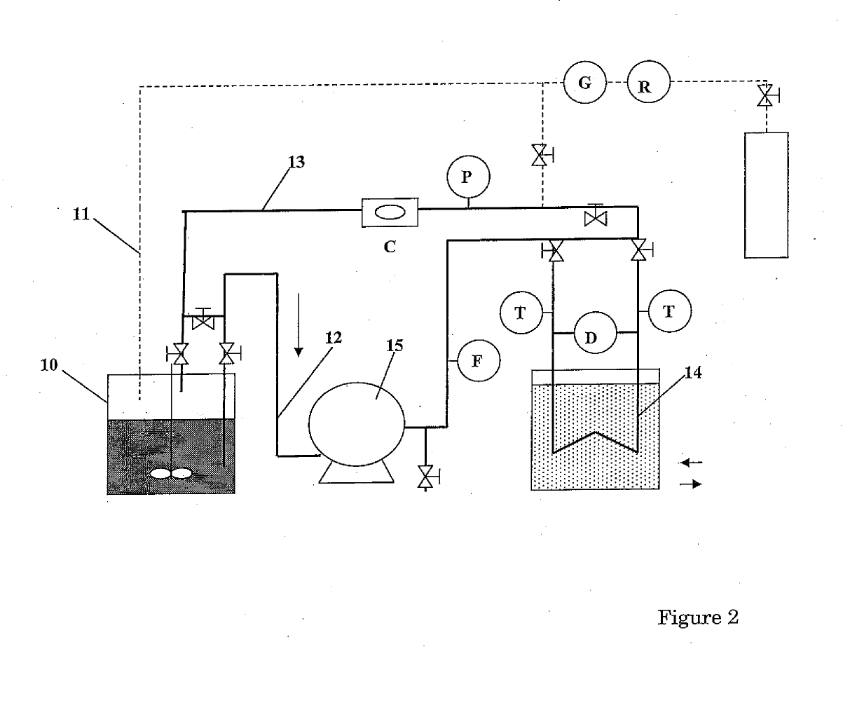

In order to test the efficiency of using a non-water-miscible solvent and amphiphilic compounds used in the method according to the invention, we simulated the hydrates formation stage and their transportation for a gas mixture containing methane and CO, in the device described by FIG. 2.

The device comprises a 1.5-liter reactor 10 comprising an inlet 11 and an outlet for the gas, an inlet 12 and an outlet 13 for the liquid. These liquid inlet and outlet are connected to a 10-m long circulation loop 14 made up of tubes that are 7.7 mm in inside diameter.

Tubes having the same diameter as the loop provide circulation of the fluids from the loop to the reactor, and conversely, by means of a gear pump 15 located between them. A sapphire cell C integrated in the circuit allows to display the circulating liquid and the hydrates if formed.

To determine the efficiency of the additives according to the invention, the liquid(s) (water or water+solvent+additive) are fed into the reactor with a volume of 1.4 l. The pressure in the device is then raised up to 7 MPa by means of the gas studied.

Homogenization of the liquids is provided by their circulation in the loop and the reactor. By following the pressure drop and flow rate variations, a fast temperature decrease from 17° C. to 4° C. (below the hydrate formation temperature) is applied. The temperature is then maintained at this value.

The tests can last from some minutes to some hours. The conversion ratio of water to hydrates is calculated and the transportability of the hydrate slurry once formed is studied when transportation is possible. In this case, pressure drop DP and flow rate F in the loop are stable.

The following examples illustrate the invention and should not be considered to be limitative. Example 1 is given by way of comparison.

### EXAMPLE 1

We operate with a liquid consisting of 100% water. The gas used comprises, by mole, 90% methane, 2% nitrogen and 8% CO₂. The reactor and the loop are pressurized at 7 MPa, then gas delivery is stopped. Under such conditions, a 1.45 MPa pressure decrease is observed. As soon as hydrates form, the pump flow rate becomes unstable, the pressure drop between the inlet and the outlet of the loop increases significantly and reaches its maximum value. The mixture is not properly pumped. Complete clogging due to the hydrates occurs within twenty minutes. The hydrates form a block and circulation of the fluid becomes impossible. The proportion of water converted to hydrates is 3%.

### EXAMPLE 2

We operate as in comparative Example 1, but with a fluid made up, by volume, of 10% water and 90% solvent to which an amphiphilic compound obtained by reaction between a succinic polyisobutenyl anhydride and polyethylene glycol is added. The amphiphilic compound is added at a concentration of 0.17% by weight in relation to the volume of solvent. The composition by weight of the solvent is as follows:
for the molecules having less than 11 carbon atoms: 20% paraffins and isoparaffins, 48% naphthenes, 10% aromatics,
for the molecules having at least 11 carbon atoms: 22% of a mixture of paraffins, isoparaffins, naphthenes and aromatics.

Under such conditions, a 1.95 MPa pressure decrease is observed, the pressure in the system reaches the equilibrium curve of the methane hydrates. The flow rate and the pressure drop after hydrate formation in the loop are stable, which means that the hydrate slurry remains pumpable. The conversion ratio of water to hydrate reaches 46%. The final composition of the gas mixture is 4.2% CO₂, 3% nitrogen and 92.8% methane. The gas that is released by dissociation of the hydrate phase eventually contains 19% by mole CO₂ and 81% by mole methane, and no N₂. The method has thus allowed to enrich the gas resulting from the dissociation in CO₂ from 8% to 19% by mole.

1. A method of enriching a gaseous effluent with acid compounds, comprising the following stages:
feeding into a contactor a feed gas and a mixture of at least two liquid phases non-miscible with one another, including an aqueous phase, the feed gas containing at least acid compounds,
establishing in said contactor predetermined pressure and temperature conditions for the formation of hydrates consisting of water and of said acid compounds,
carrying said hydrates dispersed in the phase non-miscible in the aqueous phase by pumping to a hydrate dissociation drum,
establishing in said drum the hydrate dissociation conditions,
discharging the gas resulting from the dissociation, said gas being enriched in acid compounds in relation to the feed gas.

2. A method as claimed in claim 1, wherein the hydrate dispersion pressure is increased by a factor ranging between 2 and 200 times the feed gas pressure.

3. A method as claimed in claim 1, wherein at least one non-ionic, anionic, cationic or zwitterionic amphiphilic compound having at least the hydrate anti-agglomeration property is added to said mixture.

4. A method as claimed in claim 3, wherein said amphiphilic compound comprises a hydrophilic part and a part having a high affinity with the phase non-miscible with the aqueous phase.

5. A method as claimed in claim 1, wherein the phase non-miscible with the aqueous phase is selected from among the following group: hydrocarbon-containing solvents, silicone type solvents, halogenated or perhalogenated solvents and their mixtures.

6. A method as claimed in claim 5, wherein the hydrocarbon-containing solvents are selected from among the following group:
aliphatic cuts, notably isoparaffinic cuts,
organic solvents of aromatic cut or naphthenic cut type,
branched alkanes, cycloalkanes and alkylcycloalkanes, aromatic compounds, alkylaromatics,
and wherein the hydrocarbon-containing solvent has a flash point above 40° C., preferably above 75° C. and more precisely above 100° C., and a crystallization point below −5° C.

7. A method as claimed in claim 5, wherein the silicone type solvents, alone or in admixture, are selected from among the following group:
linear polydimethylsiloxanes (PDMS) of (CH₃)₃-SiO-[(CH₃)₂-SiO]ₙ-Si(CH₃)₃ type with n ranging between 1 and 900, corresponding to viscosities at ambient temperature ranging between 0.1 and 10,000 mPa.s,
polydiethylsiloxanes in the same viscosity range,
cyclic polydimethylsiloxanes D₄ to D₁₀, preferably D₅ to D₈. Unit D represents the monomer unit dimethylsiloxane,
poly(trifluoropropyl methyl siloxanes).

8. A method as claimed in claim 5, wherein the halogenated or perhalogenated solvents are selected from among the perfluorocarbides (PFC), hydrofluoroethers (HFE), perfluoropolyethers (PFPE),
and wherein the halogenated or perhalogenated solvent has a boiling point greater than or equal to 70° C. at atmospheric pressure and a viscosity below 1 Pa.s at ambient temperature and atmospheric pressure.

9. A method as claimed in claim 3, wherein said non-ionic amphiphilic compound comprises:
a hydrophilic part comprising either alkylene oxide groups, hydroxy or amino alkylene groups,
a hydrophobic part comprising a hydrocarbon chain derived from an alcohol, a fatty acid, an alkylated derivative of a phenol or a polyolefin, preferably derived from isobutene or butene.

10. A method as claimed in claim 9, wherein said non-ionic amphiphilic compound is selected from among the following group: oxyethylated fatty alcohols, alkoxylated alkylphenols, oxyethylated and/or oxypropylated derivatives, sugar ethers, polyol esters, such as glycerol, polyethylene glycol, sorbitol and sorbitan, mono and diethanol amides, carboxylic acid amides, sulfonic acids or amino acids.

11. A method as claimed in claim 3, wherein said anionic amphiphilic compound is selected from among the following group:
carboxylates such as metallic soaps, alkaline soaps or organic soaps, such as N-acyl amino acids, N-acyl sarcosinates, N-acyl glutamates and N-acyl polypeptides,
sulfonates such as alkylbenzenesulfonates, paraffin and olefin sulfonates, ligosulfonates or sulfonsuccinic derivatives, such as sulfosuccinates, hemisulfosuccinates, dialkylsulfosuccinates, for example sodium dioctyl-sulfosuccinate,
sulfates such as alkylsulfates, alkylethersulfates and phosphates.

12. A method as claimed in claim 3, wherein said cationic amphiphilic compound is selected from among the following group:
alkylamine salts:
alkylamine ethers,
quaternary ammonium salts such as alkyl trimethyl ammonium derivatives or tetra-alkylammonium derivatives or alkyl dimethyl benzyl ammonium derivatives,
alkoxylated alkyl amine derivatives,
sulfonium or phosphonium derivatives, for example tetra-alkyl phosphonium derivatives,
heterocyclic derivatives such as the pyridinium, imidazolium, quinolinium, piperidinium or morpholinium derivatives.

13. A method as claimed in claim 3, wherein said zwitterionic amphiphilic compound is selected from among the following group: betaines, alkyl amido betaine derivatives, sulfobetaines, phosphobetaines, carboxybetaines.

14. A method as claimed in claim 3, wherein said amphiphilic compound comprises a silicone or fluoro-silicone part.

15. A method as claimed in any claim 3, wherein said amphiphilic compound comprises a halogenated or perhalogenated part.

16. A method as claimed in claim 1, wherein the proportions of the water/solvent mixture respectively range between 0.5/99.5 and 60/40% by volume, preferably between 10/90 and 50/50% by volume, and more precisely between 20/80 and 40/60% by volume.

17. A method as claimed in claim 3, wherein said amphiphilic compound is added to said mixture in a proportion ranging between 0.1 and 10% by weight, preferably between 0.1 and 5% by weight, in relation to the phase non-miscible in the aqueous phase.
